(19) United States
(12) Patent Application Publication
(10) Pub. No.: US 2025/0123506 A1
(43) Pub. Date: Apr. 17, 2025

(54) High-efficiency thin-film electro-optical modulator on silicon photonics platform

(71) Applicant: Marvell Asia Pte Ltd, Singapore (SG)

(72) Inventors: Masaki Kato, Palo Alto, CA (US); Xiaoguang Tu, Singapore (SG); Louise Wang, Cupertino, CA (US); Aimin Xing, Irvine, CA (US)

(21) Appl. No.: 18/911,296

(22) Filed: Oct. 10, 2024

Related U.S. Application Data
(60) Provisional application No. 63/543,925, filed on Oct. 12, 2023.

(51) Int. Cl. G02F 1/035

(52) U.S. Cl. CPC G02F 1/0356; G02F 2202/20

(57) ABSTRACT

An electro-optical modulator includes a substrate and an optical waveguide including an electro-optical thin film disposed on the substrate. The optical waveguide has an input end coupled to receive an optical signal and an output end opposite the input end. First and second electrodes are disposed on the substrate along opposite sides of the waveguide. A differential driver has first and second differential outputs coupled to apply a differential electrical signal between the first and second electrodes to modulate a polarization of the optical signal propagating in the waveguide.

### CROSS-REFERENCE TO RELATED APPLICATION

This application claims the benefit of U.S. Provisional Patent Application 63/543,925, filed Oct. 12, 2023, which is incorporated herein by reference.

### FIELD OF THE INVENTION

The present invention relates generally to optical communication devices, and particularly to electro-optical modulators.

### BACKGROUND

The need for high-speed connectivity of electronic systems is rising rapidly, with the recent interest in AI-based platforms, such as ChatGPT, pushing the requirements for connectivity and processing even further. These requirements may be satisfied by photonic circuits and waveguides, in which high-speed electro-optical amplitude modulators are key elements. These modulators are required to have, in addition to a high modulation speed, high efficiency, i.e., a low switching voltage, and low optical losses. Silicon-based electro-optical modulators provide a solution for communication speeds up to about 128 GBd (giga-baud) but are unable to meet all the above requirements for speeds reaching 200 GBd.

### SUMMARY

Embodiments of the present invention that are described hereinbelow provide improved designs for electro-optical modulators.

There is therefore provided, in accordance with an embodiment of the invention, an electro-optical modulator, including a substrate and an optical waveguide including an electro-optical thin film disposed on the substrate. The optical waveguide has an input end coupled to receive an optical signal and an output end opposite the input end. First and second electrodes are disposed on the substrate along opposite sides of the waveguide. A differential driver has first and second differential outputs coupled to apply a differential electrical signal between the first and second electrodes to modulate a polarization of the optical signal propagating in the waveguide.

In a disclosed embodiment, the optical waveguide has a waveguide axis along which the optical signal propagates, and the electro-optical thin film includes a uniaxial crystal, which is disposed on the substrate with a crystal Z-axis oriented perpendicularly to the substrate and a crystal Y-axis oriented parallel to the waveguide axis.

In some embodiments, the optical signal at the input end of the optical waveguide has a linear polarization, and the modulator includes a controller coupled to control the differential driver to modulate a rotation of the linear polarization of the optical signal exiting the output end of the optical waveguide. In a disclosed embodiment, the modulator includes third and fourth electrodes disposed on the substrate on opposite sides of the waveguide between the input end and the first and second electrodes, wherein the controller is coupled to apply a DC voltage between the third and fourth electrodes to adjust an input angle of the linear polarization of the optical signal prior to modulation of the polarization.

Additionally or alternatively, the modulator includes third and fourth electrodes disposed on the substrate alongside the first and second electrodes, respectively, wherein the first and second electrodes are disposed between the third and fourth electrodes and the waveguide, wherein the third and fourth electrodes are grounded, and the first, second, third, and fourth electrodes define a differential transmission line extending along the waveguide.

Further additionally or alternatively, the modulator includes an optical polarizer coupled to receive the optical signal from the output end of the optical waveguide to generate, in response to the differential signal, an amplitude-modulated output beam responsively to the modulated polarization.

In disclosed embodiments, the electro-optical thin film is selected from a set of materials consisting of lithium niobate (LiNbO3), lithium tantalate (LiTaO3), and barium titanate (BaTiO3).

In one embodiment, the substrate includes a silicon photonics circuit. Alternatively, the substrate includes the electro-optical thin film.

There is also provided, in accordance with an embodiment of the invention, a dual-polarization coherent modulator including a substrate and at least first and second electro-optical modulators. Each electro-optical modulator includes an optical waveguide including an electro-optical thin film disposed on the substrate and first and second electrodes disposed on the substrate along opposite sides of the waveguide. A differential driver has first and second differential outputs coupled to apply a differential signal between the first and second electrodes to rotate a polarization of optical signals propagating in the waveguide. An optical polarizer is coupled to receive the optical signals from the waveguide to generate an amplitude-modulated output beam. A splitter is coupled to divide a coherent input beam between respective input ends of the at least first and second electro-optical modulators. A combiner is coupled to combine respective amplitude-modulated output beams generated by the at least first and second modulators while rotating a polarization of at least one of the amplitude-modulated output beams to generate a combined beam including dual polarizations.

In a disclosed embodiment, the at least first and second electro-optical modulators include first, second, third and fourth modulators, wherein the first, second, third and fourth modulators are configured to apply an in-phase modulation and a quadrature modulation to each of the dual polarizations.

There is additionally provided, in accordance with an embodiment of the invention, a method for producing an electro-optical modulator. The method includes depositing an optical waveguide including an electro-optical thin film disposed on a substrate and coupling an input end of the optical waveguide to receive an optical signal. First and second electrodes are deposited on the substrate along opposite sides of the waveguide. A controller is coupled to apply a differential electrical signal between the first and second electrodes to modulate a polarization of the optical signal propagating in the waveguide.

There is further provided, in accordance with an embodiment of the invention, a method for modulating an optical signal. The method includes providing an electro-optical modulator including an optical waveguide, which includes an electro-optical thin film disposed on a substrate and first and second electrodes disposed on the substrate along opposite sides of the waveguide. The optical signal is input to an input end of the optical waveguide. A differential electrical signal is applied between the first and second electrodes to modulate a polarization of the optical signal propagating in the optical waveguide.

The present invention will be more fully understood from the following detailed description of the embodiments thereof, taken together with the drawings in which:

### BRIEF DESCRIPTION OF THE DRAWINGS

FIG. 1 is a schematic diagram of an electro-optical modulator, in accordance with an embodiment of the invention;

FIG. 2 is a schematic diagram of an electro-optical modulator, in accordance with another embodiment of the invention; and

FIG. 3 is a schematic diagram of a dual-polarization coherent modulator, in accordance with an embodiment of the invention.

### DETAILED DESCRIPTION OF EMBODIMENTS

Recently, thin-film lithium niobate (TFLN) has gained attention as a material of choice for high-speed optical modulators due to its high bandwidth, low loss and high efficiency, albeit at the cost of larger device size. The electro-optical properties of lithium niobate (LiNbO3) allow optical phase modulation and polarization rotation, depending on the direction of the applied electrical field and the direction of the propagating optical signal with respect to the crystal axes of the material. TFLN modulators have been integrated onto silicon photonics platforms, but there is a need for further increases in the efficiency of the modulators, as well as a reduction in their size.

The embodiments of the present invention that are described herein provide a novel approach to polarization modulation using a TELN waveguide on a silicon photonic circuit with a differential electrical drive. The TELN is oriented in a so-called Z-cut orientation, with the Z-axis of the crystal perpendicular to the substrate and with its Y-axis in the direction of the waveguide axis. Electrodes on opposite sides of the waveguide are coupled to the two differential outputs of a differential driver. By appropriate choice of the drive voltage, the polarization of an optical signal propagating in the waveguide can be rotated with high efficiency, due to both the proximity of the electrodes to the waveguide and to the orientation of the crystal axes of the TELN with respect to the electric field. In some embodiments, an optical polarizer at the output end of the TELN waveguide converts the rotation of the polarization into a modulation of the amplitude of the optical signal.

In addition to this sort of single-channel amplitude modulation, dual-polarization coherent modulation may also be implemented using the same principles.

As an alternative to lithium niobate, other uniaxial electro-optic materials may be used, such as lithium tantalate (LiTaO3) and barium titanate (BaTiO3). As another alternative, instead of integrating the TFLN waveguide with a silicon photonic circuit, the TELN modulator may be used as a stand-alone unit, wherein all its passive components and phase tuners are fabricated on TFLN.

Thus, in the disclosed embodiments, an electro-optical modulator comprises a substrate and an optical waveguide comprising a uniaxial electro-optical thin film disposed on the substrate. Two electrodes are formed on the substrate along opposite sides of the waveguide, and a differential driver applies a differential electrical signal between the electrodes to modulate the polarization of an optical signal propagating in the waveguide. For this purpose, in some embodiments, the thin film is deposited on the waveguide with the crystal Z-axis of the electro-optical material oriented perpendicularly to the substrate and the crystal Y-axis oriented parallel to the waveguide axis.

In some embodiments, the optical signal at the input to the optical waveguide has a linear polarization, and the differential driver is controlled to modulate the rotation of the linear polarization of the optical signal exiting the output end of the optical waveguide. A polarizer at the output end of the optical waveguide may be used to convert the polarization-modulated optical signal to an amplitude-modulated output beam.

In further disclosed embodiments, a dual-polarization coherent modulator comprises a substrate and at least first and second electro-optical modulators of the type described above, each with its own differential driver and optical polarizer to generate respective amplitude-modulated output beams. A splitter divides a coherent input beam between respective input ends of the electro-optical modulators, and a combiner combines the respective amplitude-modulated output beams while rotating the polarization of at least one of the output beams to generate a combined beam including dual polarizations. In one embodiment, four electro-optical modulators are deployed in this configuration to apply in-phase (I) and quadrature (Q) modulations to each of the dual polarizations.

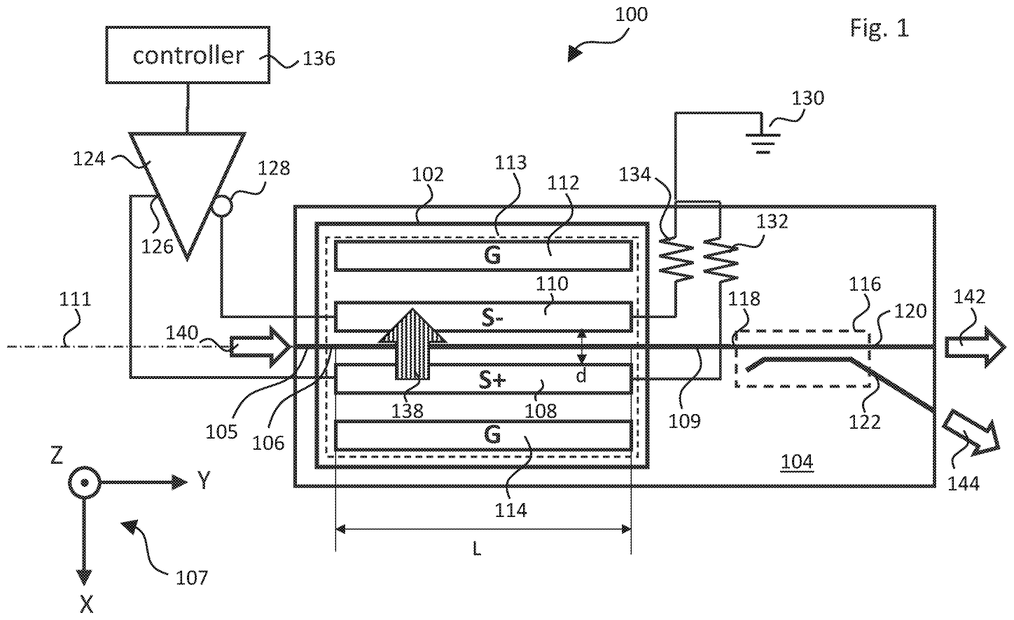

FIG. 1 is a schematic top view of an electro-optical modulator 100, in accordance with an embodiment of the invention.

Modulator 100 comprises a waveguide 106, having a waveguide axis 111. Waveguide 106 is formed, for example by a photolithographic process, in a Z-cut thin-film lithium niobate (TFLN) layer 102 disposed on a substrate of a silicon photonic circuit 104. In the present embodiment, the Y- and Z-axes of Cartesian coordinates 107 coincide with the respective crystal axes of TELN layer 102, with the crystal Z-axis of the TFLN layer oriented perpendicularly to the silicon photonic circuit 104 and the crystal Y-axis oriented parallel to axis 111 of waveguide 106. (In accordance with customary usage in the field of crystal optics, the Z-axis is the direction along which optical rays can propagate in the uniaxial crystal without birefringence.)

Positive and negative signal electrodes 108 and 110, labeled S+ and S− respectively, are deposited along opposite sides of waveguide 106, and ground electrodes 112 and 114, labeled G, are deposited adjacent to the signal electrodes. Signal electrodes 108 and 110 together with ground electrodes 112 and 114 form a differential transmission line 113 extending along waveguide 106.

Modulator 100 further comprises a polarizer 116, comprising an input 118 and two outputs 120 and 122, disposed on silicon photonic circuit 104. An output end 109 of waveguide 106 is coupled to input 118 of polarizer 116, with the polarizer directing a TE-polarized mode propagating in the waveguide to output 120 and a TM-polarized mode to output 122. (TE-polarization is defined as having an electric field (E-field) in the X-direction, and TM-polarization is defined as having the E-field in the Z-direction.)

A differential driver 124, comprising differential positive and negative outputs 126 and 128, drives modulator 100 with a differential signal between the two outputs. Positive output 126 is coupled to positive signal electrode 108, and negative output 128 is coupled to negative signal electrode 110. The drive circuit is closed by coupling signal electrodes 108 and 110 to a ground 130 via respective load resistors 132 and 134. A controller 136 applies a modulation signal to differential driver 124 which accordingly generates a radiofrequency (RF) electric field 138 of magnitude Ex across waveguide 106 in the X-direction. In this configuration, differential driver 124 is able to drive the differential transmission line defined by electrodes 108, 110, 112 and 114 at a high baud rate, for example 200 GBd or more, while the close proximity of signal electrodes 108 and 110 to waveguide 106 contributes to a high Ex field within the waveguide and thus strong optical modulation over a short modulation length.

In some embodiments, controller 136 comprises a programmable controller, which is programmed in software and/or firmware to carry out the functions that are described herein. Additionally or alternatively, at least some of the functions of controller 136 may be carried out by hardware logic circuits, which may be hard-wired or programmable. In either case, controller 88 has suitable interfaces for receiving and transmitting data and instructions to and from other elements of device 100 as required.

The electro-optical properties of LiNbO3 are given by an electro-optic tensor T:

$$T = [ \begin{matrix}0 & - {r}_{22} & {r}_{13} \\ 0 & {r}_{22} & {r}_{13} \\ 0 & 0 & {r}_{33} \\ 0 & {r}_{51} & 0 \\ {r}_{51} & 0 & 0 \\ - {r}_{22} & 0 & 0\end{matrix} ] , \qquad [ Eqn . 1 ]$$

wherein the non-zero coefficients rᵢⱼ of tensor T have the following values:

$${r}_{13} = 8.6 pm / V ,$$

$${r}_{22} = 3.4 pm / V ,$$

$${r}_{33} = 30.8 pm / V , and$$

$${r}_{51} = 28 pm / V .$$

The ordinary and extraordinary refractive indexes, respectively, of LiNbO3 have the values no=2.21 and ne=2.13.

The index ellipsoid for the optical signal propagating in the Y-direction in waveguide 106, with an applied electric field Ex, becomes:

$$\frac{{X}^{2}}{{n}_{o}^{2}} + \frac{{Z}^{2}}{{n}_{e}^{2}} + {r}_{51} {E}_{x} Z X = 1. \qquad [ Eqn . 2 ]$$

As is seen from Egn. 2 for the index ellipsoid, for Z-cut TFLN 102 with field 138 in the X-direction, the second-largest coefficient r51 of electro-optic tensor T is utilized. By defining new Cartesian axes X′ and Z′ in diagonal directions (removing the cross term ZX), the index ellipsoid of Eqn. 2 may be written as:

$$( \frac{1}{{n}_{e}^{2}} - {r}_{51} {E}_{x} ) {Z}^{′2} + ( \frac{1}{{n}_{o}^{2}} + {r}_{51} {E}_{x} ) {X}^{′2} = 1. \qquad [ Eqn . 3 ]$$

The differential changes of the refractive index along the X′- and Z′-axes due to the electric field Ex may be written as:

$$Δ {n}_{{X}^{′}} = - \frac{1}{2} {n}_{o}^{2} {r}_{51} {E}_{x} and \qquad [ Eqn . 4 ]$$

$$Δ {n}_{{Z}^{′}} = + \frac{1}{2} {n}_{e}^{2} {r}_{51} {E}_{x} . \qquad [ Eqn . 5 ]$$

When a linearly polarized input beam 140 is launched into waveguide 106 through an input end 105, the polarization of the optical signal propagating in the waveguide rotates due to the birefringence expressed by Eqns. 4 and 5. Thus, the polarization state of the optical signal at output end 109 is modulated by the electric field Ex applied by differential driver 124. This polarization-modulated optical signal is coupled to input 118 of polarizer 116, which subsequently converts the signal to amplitude modulated TE- and TM-polarized output signals at respective outputs 120 and 122. The TE- and TM-polarized signals are emitted from silicon photonic circuit 104 through edge couplers or other suitable couplers as respective output beams 142 and 144.

The modulation efficiency VpL of electro-optic modulator 100 is defined as the voltage V across signal electrodes 108 and 110, multiplied by the length L of waveguide 106 located between the signal electrodes, which “turns off” the output of the modulator. Specifically, if input beam 140 is TE-polarized, so that at zero applied voltage the optical signal exits the modulator only through output 120 as beam 142 (with no beam 144), applying the voltage V defined hereinabove rotates the original TE-polarization over the length L by 90O to TM. Consequently, polarizer 116 directs the optical signal received at its input 118 in its entirety to its output 122 and further to beam 144, extinguishing beam 142.

For modulator 100, the modulation efficiency VpL can be written as:

$$V π L = \frac{λ d}{{r}_{51} ( {n}_{o}^{3} + {n}_{e}^{3} )} , \qquad [ Eqn . 6 ]$$

wherein \ is the wavelength of the light propagating in waveguide 106, and d is the separation between signal electrodes 108 and 110. The value of the modulation efficiency VAL is low (with “low” being advantageous for a modulator) due to the fact that the denominator has both the second largest coefficient r₅₁ of the electro-optic tensor T and the sum of the cubes of the ordinary and extraordinary refractive indexes no and ne. The low value of VπL, combined with a high field Eₓ (as described hereinabove), contributes to an overall high efficiency of modulator 100.

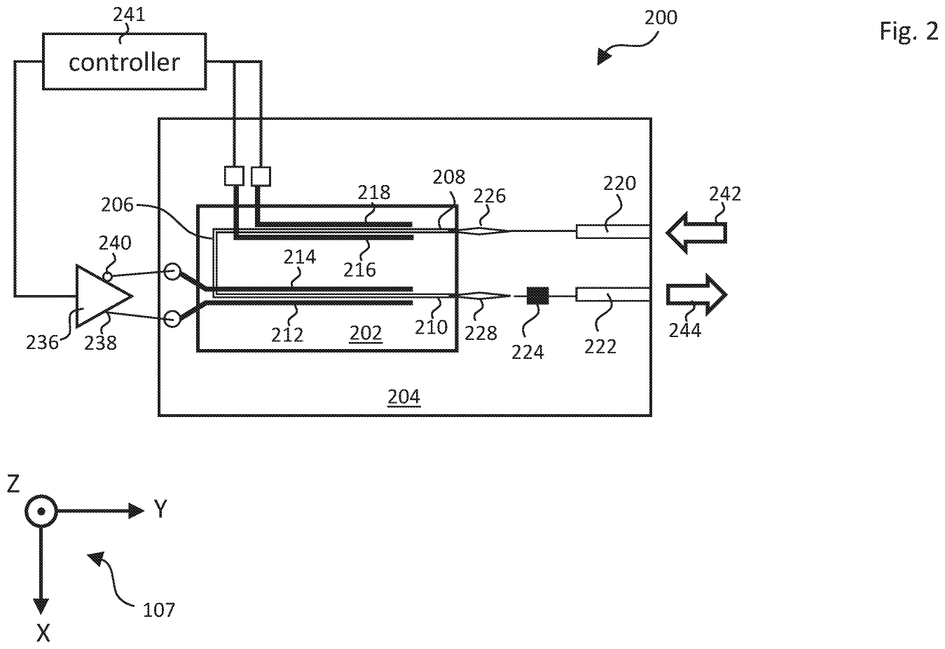

FIG. 2 is a schematic diagram of an electro-optical modulator 200, in accordance with another embodiment of the invention. Modulator 200 is similar to modulator 100 (FIG. 1), with the addition of input polarization control, as described below. For the sake of simplicity, some of the components shown in FIG. 1 (such as elements of the differential transmission line) are omitted from FIG. 2.

Modulator 200 comprises, similarly to modulator 100, a waveguide 206 formed in a Z-cut thin-film lithium niobate (TFLN) layer 202 disposed on a silicon photonic circuit 204. Waveguide 206 has a U-shape in this example, with an input end 208 and an output end 210. Positive and negative signal electrodes 212 and 214, respectively, are disposed on TELN layer 202 along opposite sides of waveguide 206. Additionally, DC electrodes 216 and 218 are disposed on TELN layer 202 along opposite sides of waveguide 206 between input end 208 and signal electrodes 212 and 214. Modulator 200 further comprises, on silicon photonic circuit 204, an input coupler 220, an output coupler 222, a polarizer 224, and transition couplers 226 and 228. Input and output couplers 220 and 222 comprise, for example, edge couplers, grating couplers or other suitable couplers. Polarizer 224 may alternatively comprise a polarizing beamsplitter.

Input coupler 220 is coupled through transition coupler 226 to input end 208 of waveguide 206. The transition coupler matches the mode of guided optical signals from silicon photonic circuit 204 into TELN layer 202. Output end 210 of waveguide 206 is coupled through transition coupler 228 (similar to transition coupler 226) and further through polarizer to output coupler 222.

Similarly to modulator 100 (FIG. 1), a differential driver 236 drives modulator 200, with outputs 238 and 240 of the driver coupled to respective signal electrodes 212 and 214. A controller 241, similar to controller 136 (FIG. 1), is coupled to differential driver 236 and to DC electrodes 216 and 218.

A linearly polarized input beam 242 is received through input coupler 220 into silicon photonic circuit 204. The guided optical signal is conveyed through transition coupler 226 to input end 208 of waveguide 206. Controller 241 applies a DC-voltage to DC electrodes 216 and 218, which rotates the polarization angle of the optical signal propagating in waveguide 206 from an initial polarization angle f0 to a new, fixed polarization angle f1. Polarization angle f1 sets the operating point for the RF polarization modulation of the optical signal passing between signal electrodes 212 and 214. The polarization-modulated optical signal exits waveguide 206 through output end 210 and is conveyed via transition coupler 228 to polarizer 224, which, in turn, converts the polarization modulation to amplitude modulation. The amplitude-modulated wave is conveyed to output coupler 222, where it exits modulator 200 as an output beam 244. The overall effect of the DC voltage applied to DC electrodes 216 and 218 is to shift the range of amplitude modulation of output beam 244 for a given range of modulation voltage between signal electrodes 212 and 214.

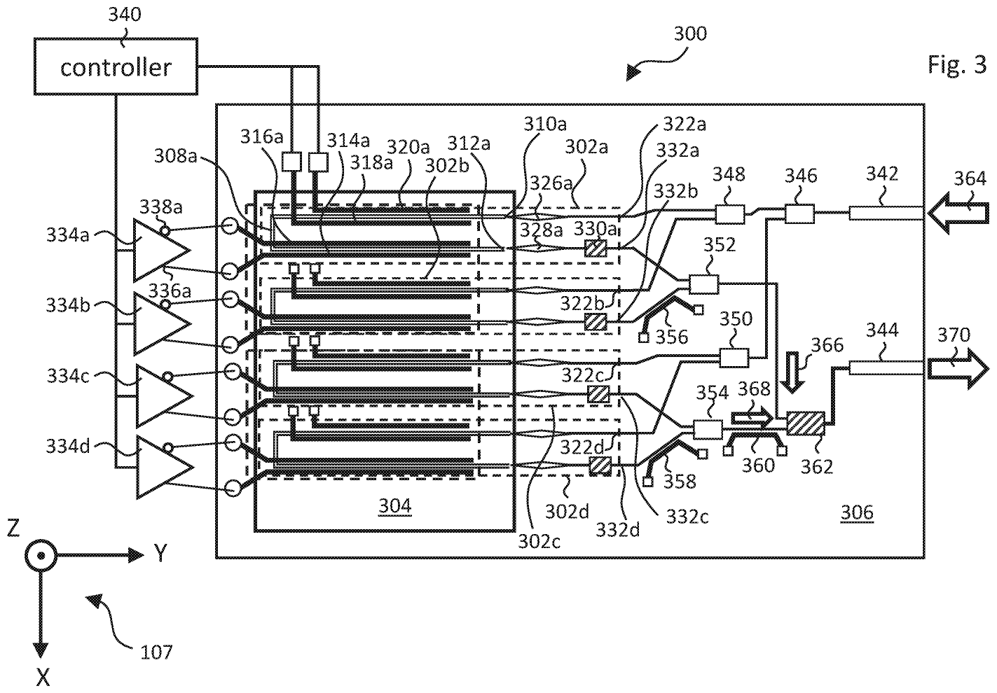

FIG. 3 is a schematic diagram of a dual-polarization coherent modulator 300, in accordance with an embodiment of the invention.

Dual-polarization coherent modulator 300 comprises four modulators, each of them similar to modulator 200 (FIG. 2): Modulator 302a, modulator 302b, modulator 302c and modulator 302d, demarcated by dashed lines. For the sake of clarity, only the items in modulator 302a are labeled in the figure (with the exception of the inputs to and outputs from modulators 302b-302d.) All four modulators 302a-302d are formed in a Z-cut TELN layer 304 and disposed on a silicon photonic circuit 306.

Modulator 302a comprises a U-shaped TELN waveguide 308a, with an input end 310a and an output end 312a. Signal electrodes 314a and 316a are disposed along opposite sides of waveguide 308a, and DC electrodes 318a and 320a are disposed alongside the waveguide between input end 310a and the signal electrodes. An optical input 322a of modulator 302a is coupled through a transition coupler 326a to input end 310a. Output end 312a is coupled through a transition coupler 328a and a polarizer 330a (or alternatively a polarizing beamsplitter) to an output 332a of modulator 302a.

A differential driver 334a drives modulator 302a, with outputs 336a and 338a of the driver coupled to respective signal electrodes 314a and 316a. Similar differential drivers 334b-334d are coupled to drive respective modulators 302b-302d. A controller 340, similar to controller 241 (FIG. 2) but with added channels, is coupled to differential drivers 334a-334d and to DC electrodes 318a and 320a of modulator 302a, as well as to the respective DC electrodes of modulators 302b-302d.

Dual-polarization coherent modulator 300 further comprises the following components integrated onto silicon photonic circuit 306: An input coupler 342 and an output coupler 344 (edge couplers or grating couplers), waveguide splitters 346, 348 and 350, waveguide combiners 352 and 354, phase tuners 356, 358 and 360, and polarization rotator combiner 362, with their functionalities further detailed hereinbelow. Controller 340 drives phase tuners 356, 358 and 360. Both the active and passive guided-wave components of modulator 300 are designed to preserve the transverse mode structure and the coherence of both TE- and TM-polarized signals propagating in the modulator.

A TE-polarized coherent input beam 364 enters modulator 300 through input coupler 342. It propagates as a guided optical signal to splitter 346, which splits the signal into two. Each split signal is further split into two by respective splitters 348 and 350. The resulting four optical signals propagate to the respective inputs 322a, 322b, 322c and 322d of modulators 302a, 302b, 302c and 302d.

The operation of modulator 302a will now be described by way of example. From input 322a of modulator 302a, the optical signal transitions to waveguide 308a through transition coupler 326a. Controller 340 applies a DC-voltage to DC electrodes 318a and 320a, which rotates the polarization angle of the optical signal propagating in waveguide 308a, setting the initial polarization of the guided wave. Signal electrodes 314a and 316a are driven by controller 340 and differential driver 334a with an RF signal to rotate the polarization. The optical signal exits waveguide 308a through output end 312a and transition coupler 328 into polarizer 330a, which converts the polarization-modulated signal into an amplitude-modulated signal, which exits at modulator output 332a. In a similar way, each of the remaining three modulators 302b, 302c and 302d produces an amplitude-modulated signal exiting from respective outputs 332b, 332c and 332d.

The phases of the optical signals exiting from modulators 302b and 302d are shifted by respective phase tuners 356 and 358 to be 90O out of phase with the signals exiting from modulators 302a and 302b. These phase-shifted signals are pair-wise combined with the signals from modulators 302a and 302c in respective combiners 352 and 354. Combiners 352 and 354 emit respective signals shown by arrows 366 and 368, wherein phase tuners 356 and 358 have generated quadrature components in addition to the in-phase components. Signal 366 propagates directly to polarization rotator combiner 362, which transmits it as a TE-polarized signal. Signal 368 passes through phase tuner 360 which shifts the phase of the signal; it then propagates to polarization rotator combiner 362, which rotates its polarization from TE to TM while transmitting the signal.

Thus, an output beam 370 from output coupler 344 comprises both TE- and TM-polarizations, wherein the amplitude of each polarization, the phase shift between the two polarizations, and the ratio between in-phase and quadrature components of the signals have been determined by the four modulators 302a, 302b, 302c and 302d. Output beam 370 can be further conveyed in, for example, an optical fiber with connectivity to additional systems, thus providing four independent communication channels in one optical fiber.

It is noted that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An electro-optical modulator, comprising:
a substrate;
an optical waveguide comprising an electro-optical thin film disposed on the substrate, the optical waveguide having an input end coupled to receive an optical signal and an output end opposite the input end;
first and second electrodes disposed on the substrate along opposite sides of the waveguide; and
a differential driver having first and second differential outputs coupled to apply a differential electrical signal between the first and second electrodes to modulate a polarization of the optical signal propagating in the waveguide.

2. The modulator according to claim 1, wherein the optical waveguide has a waveguide axis along which the optical signal propagates, and the electro-optical thin film comprises a uniaxial crystal, which is disposed on the substrate with a crystal Z-axis oriented perpendicularly to the substrate and a crystal Y-axis oriented parallel to the waveguide axis.

3. The modulator according to claim 1, wherein the optical signal at the input end of the optical waveguide has a linear polarization, and the modulator comprises a controller coupled to control the differential driver to modulate a rotation of the linear polarization of the optical signal exiting the output end of the optical waveguide.

4. The modulator according to claim 3 and comprising third and fourth electrodes disposed on the substrate on opposite sides of the waveguide between the input end and the first and second electrodes, wherein the controller is coupled to apply a DC voltage between the third and fourth electrodes to adjust an input angle of the linear polarization of the optical signal prior to modulation of the polarization.

5. The modulator according to claim 1 and comprising third and fourth electrodes disposed on the substrate alongside the first and second electrodes, respectively, wherein the first and second electrodes are disposed between the third and fourth electrodes and the waveguide, wherein the third and fourth electrodes are grounded, and the first, second, third, and fourth electrodes define a differential transmission line extending along the waveguide.

6. The modulator according to claim 1 and comprising an optical polarizer coupled to receive the optical signal from the output end of the optical waveguide to generate, in response to the differential signal, an amplitude-modulated output beam responsively to the modulated polarization.

7. The modulator according to claim 1, wherein the electro-optical film is selected from a set of materials consisting of lithium niobate (LiNbO₃), lithium tantalate (LiTaO₃), and barium titanate (BaTiO₃).

8. The modulator according to claim 1, wherein the substrate comprises a silicon photonics circuit.

9. The modulator according to claim 1, wherein the substrate comprises the electro-optical thin film.

10. A dual-polarization coherent modulator comprising:
a substrate;
at least first and second electro-optical modulators, each electro-optical modulator comprising:
an optical waveguide comprising an electro-optical thin film disposed on the substrate;
first and second electrodes disposed on the substrate along opposite sides of the waveguide;
a differential driver having first and second differential outputs coupled to apply a differential signal between the first and second electrodes to rotate a polarization of optical signals propagating in the waveguide; and
an optical polarizer coupled to receive the optical signals from the waveguide to generate an amplitude-modulated output beam;
a splitter coupled to divide a coherent input beam between respective input ends of the at least first and second electro-optical modulators; and
a combiner coupled to combine respective amplitude-modulated output beams generated by the at least first and second modulators while rotating a polarization of at least one of the amplitude-modulated output beams to generate a combined beam including dual polarizations.

11. The modulator according to claim 10, wherein the at least first and second electro-optical modulators comprise first, second, third and fourth modulators, wherein the first, second, third and fourth modulators are configured to apply an in-phase modulation and a quadrature modulation to each of the dual polarizations.

12. A method for producing an electro-optical modulator, comprising:
depositing an optical waveguide comprising an electro-optical thin film disposed on a substrate;
coupling an input end of the optical waveguide to receive an optical signal;
depositing first and second electrodes on the substrate along opposite sides of the waveguide; and
coupling a controller to apply a differential electrical signal between the first and second electrodes to modulate a polarization of the optical signal propagating in the waveguide.

13. The method according to claim 12, wherein depositing the optical waveguide comprises depositing a uniaxial electro-optical thin film on the substrate with a crystal Z-axis of the uniaxial electro-optical thin film oriented perpendicularly to the substrate and a crystal Y-axis oriented parallel to a waveguide axis of the optical waveguide.

14. The method according to claim 12 and comprising depositing third and fourth electrodes on the substrate alongside the first and second electrodes, respectively, wherein the first and second electrodes are disposed between the third and fourth electrodes and the waveguide, wherein the third and fourth electrodes are grounded, and the first, second, third, and fourth electrodes define a differential transmission line extending along the waveguide.

15. The method according to claim 12 and comprising coupling an optical polarizer to receive the optical signal from the output end of the optical waveguide to generate, in response to the differential signal, an amplitude-modulated output beam responsively to the modulated polarization.

16. The method according to claim 12, wherein depositing the optical waveguide comprises depositing a uniaxial electro-optical thin film selected from a set of materials consisting of lithium niobate (LiNbO₃), lithium tantalate (LiTaO₃), and barium titanate (BaTiO₃).

17. The method according to claim 12, wherein depositing the optical waveguide comprises forming the optical waveguide on a silicon photonics circuit.

18. The method according to claim 12, wherein depositing the optical waveguide comprises forming the substrate from the uniaxial electro-optical thin film.

19. A method for modulating an optical signal, the method comprising:
providing an electro-optical modulator comprising an optical waveguide, which comprises an electro-optical thin film disposed on a substrate and first and second electrodes disposed on the substrate along opposite sides of the waveguide;
inputting the optical signal to an input end of the optical waveguide; and
applying a differential electrical signal between the first and second electrodes to modulate a polarization of the optical signal propagating in the optical waveguide.

20. The method according to claim 19, wherein inputting the optical signal comprises receiving the optical signal at the input end of the optical waveguide with a linear polarization, and wherein applying the differential electrical signal comprises controlling a rotation of the linear polarization of the optical signal exiting an output end of the optical waveguide.

21. The method according to claim 20 and comprising applying a DC voltage between third and fourth electrodes on opposite sides of the waveguide between the input end and the first and second electrodes to adjust an input angle of the linear polarization of the optical signal prior to modulation of the polarization.

22. The method according to claim 20 and comprising coupling an optical polarizer to receive the optical signal from the output end of the optical waveguide to generate, in response to the differential signal, an amplitude-modulated output beam responsively to the modulated polarization.
